(19) United States
(12) Patent Application Publication
(10) Pub. No.: US 2020/0050221 A1
(43) Pub. Date: Feb. 13, 2020

(54) SENSOR-EQUIPPED JOINT AND MONITORING SYSTEM USING THE SAME

(71) Applicant: FUJIKIN INCORPORATED, Osaka-shi (JP)

(72) Inventors: Koji Hiramatsu, Osaka-shi (JP); Tadayuki Yakushijin, Osaka-shi (JP)

(21) Appl. No.: 16/606,328

(22) PCT Filed: Apr. 24, 2018
(86) PCT No.: PCT/JP2018/016551

§ 371 Date: Oct. 18, 2019

(30) Foreign Application Priority Data
Apr. 28, 2017 (JP) 2017-090552

(51) Int. Cl. G05D 7/06; F16J 15/08; F16L 55/07; F16L 55/115; G01M 3/00

(52) U.S. Cl. CPC G05D 7/0635; F16J 15/08; G01M 3/00; F16L 55/1152; F16L 55/07

(57) ABSTRACT

To provide a sensor-equipped joint capable of detecting loosening of the joint positively before leakage of fluid. A seal structure including a joint member forming a flow path and a gasket facing the joint member and forming a seal with respect to the joint member, in which a surface of the joint member facing the gasket includes a first flat surface, an annular seal protrusion protruding from the first flat surface and a second flat surface formed at a position more distant from the gasket as compared with the first flat surface, and a sensor is provided in at least any one of the second flat surface and a part of the gasket facing the second flat surface.

### TECHNICAL FIELD

The present invention relates to a joint for connecting fluid flow paths or the like, which is a sensor-equipped joint capable of detecting loosening of the joint or the like.

### BACKGROUND ART

In recent years, a hydrogen station for supplying hydrogen gas as a fuel for a fuel cell of a passenger car or the like for realizing a low carbon society is becoming popular, and many pipe joints and so on are used in a piping installation used in the hydrogen station. As hydrogen gas flowing in the piping installation is used in conditions of ultra-low temperature and ultra-high pressure at −40° C. and 70 MPa or more, a joint used for the piping installation is required to have performance capable of withstanding such fluid.

As a joint used for the above hydrogen station, the use of a joint using a metal gasket which has been used in the past for a device for manufacturing semiconductors is considered based on reliability for seal performance. (Patent Literature 1)

Loosening occurs with time lapse due to transport, vibration and so on of fluid in joints, not limited to the above joint, which is a large problem particularly in the hydrogen station.

In response to the problem of loosening in the joint, normally, maintenance is performed periodically by performing additional tightening using a torque wrench or the like. However, this requires manpower and it is necessary to check all joints including joints not loosened, therefore, a great deal of time is required.

In order to perform additional tightening only with respect to a joint in which loosening occurs, it is necessary to appropriately grasp the occurrence of loosening, and it can be considered that, for example, a sensor for detecting the occurrence of loosening is provided in the joint.

There is a joint equipped with a sensor disclosed in Patent Literature 2, which has a sensor at a threaded body and a threaded nut, a front ferrule, a rear ferrule and a neck portion of the threaded body in a joint belonging to a type of a so-called 2-compression ring joint.

### CITATION LIST

### Patent Literature

Patent Literature 1: Japanese Patent No. 3517719

Patent Literature 2: Japanese Patent No. 6006446

### SUMMARY OF INVENTION

### Technical Problem

An object of the present invention is to provide a sensor-equipped joint and so on provided with a sensor for detecting loosening with respect to a joint and so on using a metal gasket.

### Solution to Problem

A seal structure according to a first aspect of the invention includes a joint member forming a flow path and a gasket facing the joint member and forming a seal with respect to the joint member, in which a surface of the joint member facing the gasket includes a first flat surface, an annular seal protrusion protruding from the first flat surface and a second flat surface formed at a position more distant from the gasket as compared with the first flat surface, and a sensor is provided in at least any one of the second flat surface and a part of the gasket facing the second flat surface.

As the sensor is provided in at least any one of the second flat surface and a part of the gasket facing the second flat surface in the seal structure according to the first aspect of the invention, the provided sensor can sense reduction of a surface pressure or the like when, for example, the joint or the like starts to be loosened. A seal part concerning the seal performance of fluid correspond to the first flat surface and the annular seal protrusion, therefore, the seal performance of the joint is in a sound state in a stage when the sensor detects reduction of the surface pressure or the like.

Accordingly, when it is configured that a warning is given in a case where the provided sensor detects a surface pressure or the like lower than a certain fixed value, only the joint in which the warning is given is required to be maintained by performing additional tightening and so on in the hydrogen station and the like where many joints are used, and it is not necessary to perform maintenance by checking all joints periodically as in the past, therefore, maintenance time can be largely reduced.

In the seal structure according to a second aspect of the invention, the sensor may be a strain sensor or a pressure sensor.

A cause of loosening of the seal structure is slight rotation to a direction loosening a screw or contraction of a material due to temperature change in a case where the tightening means for tightening the joint member and the gasket is the screw. When the screw is loosened, distortion generated at the time of tightening the screw or reduction of the surface pressure in the joint member and so on occurs, and the loosening of the joint can be positively detected by detecting the distortion, the reduction of the surface pressure and so on by the sensor.

In the seal structure according to a third aspect of the invention, the first flat surface may be positioned on an inner side than the annular seal protrusion, and the second flat surface may be positioned on an outer side than the annular seal protrusion.

The first flat surface is positioned on the inner side than the annular seal protrusion, and the second flat surface is positioned on the outer side than the annular seal protrusion, and the sensor is provided in at least any one of the second flat surface and a part of the gasket facing the second flat surface, therefore, the seal part formed by the first flat surface and the annular seal protrusion maintains the sound state in the stage when the sensor detects loosening or the like.

A joint according to a fourth aspect of the invention includes a pair of joint members forming a flow path, an annular gasket interposed between the pair of joint members and a tightening means for connecting the pair of joint members, in which surfaces of the joint members facing the gasket include first flat surfaces, annular seal protrusions protruding from the first flat surfaces and second flat surfaces formed at positions more distant from the gasket as compared with the first flat surfaces, and a sensor is provided in at least any one of the second flat surface and a part of the gasket facing the second flat surface.

In the joint according to a fifth aspect of the invention, the sensor may be a strain sensor or a pressure sensor.

In the joint according to a sixth aspect of the invention, the first flat surfaces maybe positioned on an inner side than the annular seal protrusions, and the second flat surfaces may be positioned on an outer side than the annular seal protrusions.

A closing stopper according to a seventh aspect of the invention includes a joint member forming a flow path, a disc-shaped closing plate facing the joint member and a tightening means for connecting the joint member and the closing plate, in which a surface of the joint member facing the closing plate includes a first flat surface, an annular seal protrusion protruding from the first flat surface and a second flat surface formed at a position more distant from the disc-shaped closing plate as compared with the first flat surface, and a sensor is provided in at least any one of the second flat surface and a part of the closing plate facing the second flat surface.

In the closing stopper according to an eighth aspect of the invention, the sensor may be a strain sensor or a pressure sensor.

In the closing stopper according to a ninth aspect of the invention, the first flat surface may be positioned on an inner side than the annular seal protrusion, and the second flat surface may be positioned on an outer side than the annular seal protrusion.

A monitoring system according to a tenth aspect of the invention monitors loosening of the joint in fluid supply equipment having the joint according to the fourth to sixth aspects of the invention, which includes a communication unit receiving a signal from the sensor and a determination unit determining a pass/fail of a tightening state of the joint by comparing the signal received from the sensor with a given value.

In the tenth aspect of the invention, the signal detected by the sensor attached to the joint according to the fourth to sixth aspects of the invention is received by a circuit associated with the joint or an external circuit apart from the joint by wire or wireless, thereby performing centralized management of loosening of many joints used in the hydrogen station and so on.

In the tenth aspect of the invention, a value of the surface pressure or distortion detected by the sensor provided in the sensor-equipped joint identified by a specific identification number is transmitted to a server or the like with the identification number of the sensor by wire or wireless as a signal. When the signal is processed in the server or the like, a monitoring person can be automatically informed which joint in the fluid supply equipment has which value of the surface pressure or distortion as well as whether maintenance is currently necessary or not. Due to the automatization, the labor in which a total inspection of all joints has been performed periodically can be largely reduced as well as maintenance such as additional tightening can be positively performed before leakage of fluid occurs.

In the monitoring system according to an eleventh aspect of the invention, a warning may be given when the tightening state is a fail.

As the monitoring system automatically gives a warning, it is not necessary for the monitoring person to perform monitoring constantly.

A fluid supply apparatus according to a twelfth aspect of the invention has the monitoring system according to the eleventh aspect of the invention, in which a warning is given and a valve provided in the flow path including the joint is closed and opened.

In the twelfth aspect of the invention, when the warning is given in a case where a specific joint in joints provided in the fluid supply apparatus is loosened, it is possible to automatically prevent leakage of fluid from the fluid supply apparatus by closing or opening the valve provided in the flow path even when the monitoring person is absent during nighttime or the like.

### Advantageous Effects of Invention

When adopting the sensor-equipped joint and the like according to the present invention, loosening of the joint in many joints can be positively detected before leakage of fluid, and maintenance saving labor can be performed easily.

### BRIEF DESCRIPTION OF DRAWINGS

FIG. 1 is a vertical cross-sectional view showing the entire structure of a sensor-equipped joint according to a first embodiment of the invention.

FIG. 2 is an enlarged vertical cross-sectional view showing a shape of a relevant part before tightening according to the first embodiment.

FIG. 3 is an enlarged vertical cross-sectional view showing a shape of a relevant part after tightening according to the first embodiment.

FIG. 4 is a graph showing the relation between the nut rotation angle and the tightening torque obtained at the time of tightening the sensor-equipped joint according to the first embodiment.

FIG. 5 is a vertical cross-sectional view showing the entire structure of a sensor-equipped joint according to a second embodiment of the invention.

FIG. 6 is an enlarged vertical cross-sectional view showing a shape of a relevant part before tightening according to the second embodiment.

FIG. 7 is a vertical cross-sectional view showing the entire structure of a sensor-equipped joint according to a third embodiment of the invention.

FIG. 8 is a diagram of a system for monitoring loosening of a joint in fluid supply equipment having a sensor-equipped joint.

FIG. 9 is a chart showing steps of a monitoring

### DESCRIPTION OF EMBODIMENTS

Hereinafter, a preferred embodiment of the present invention will be illustratively explained in detail with reference to the drawings. The scope of the invention is not limited to dimensions, materials, shapes, relative arrangement and so on and various manufacturing conditions of components described in the embodiment and these are merely explanatory examples unless otherwise specified.

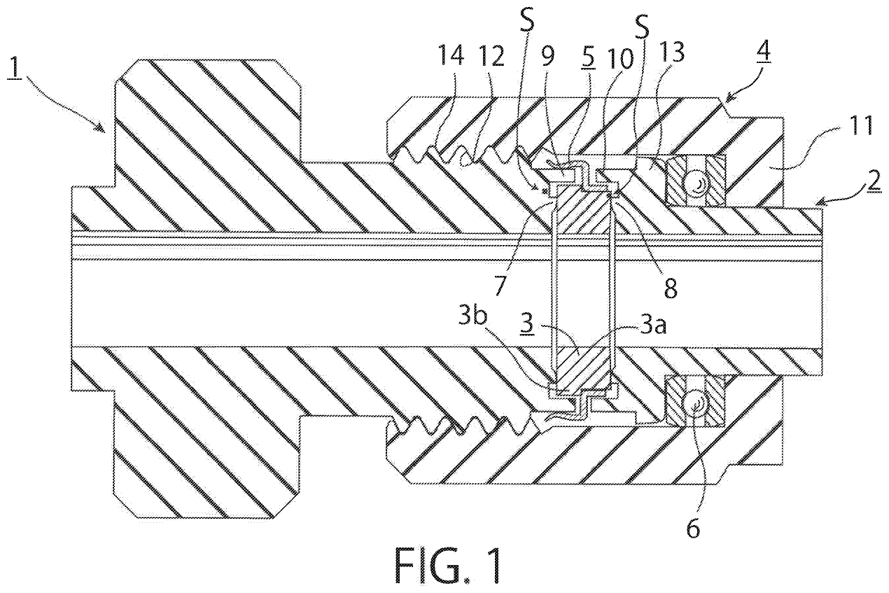

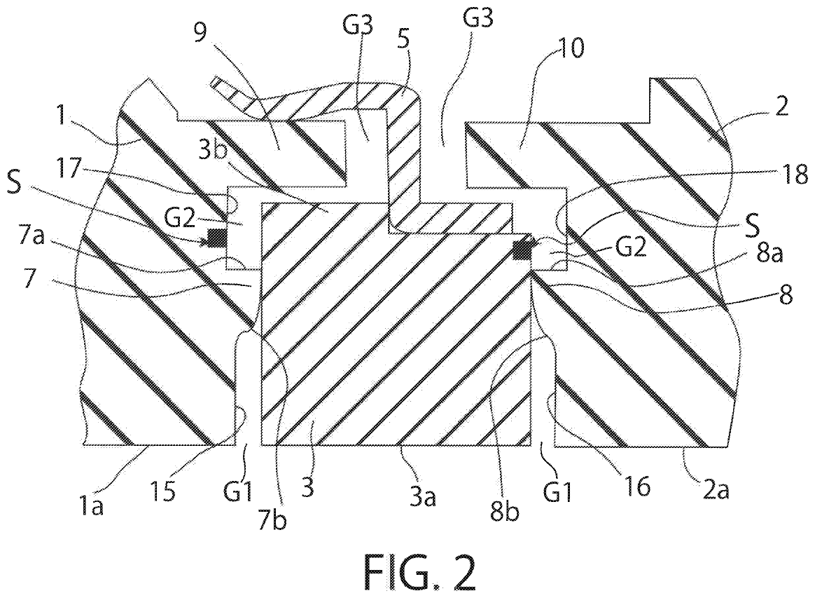

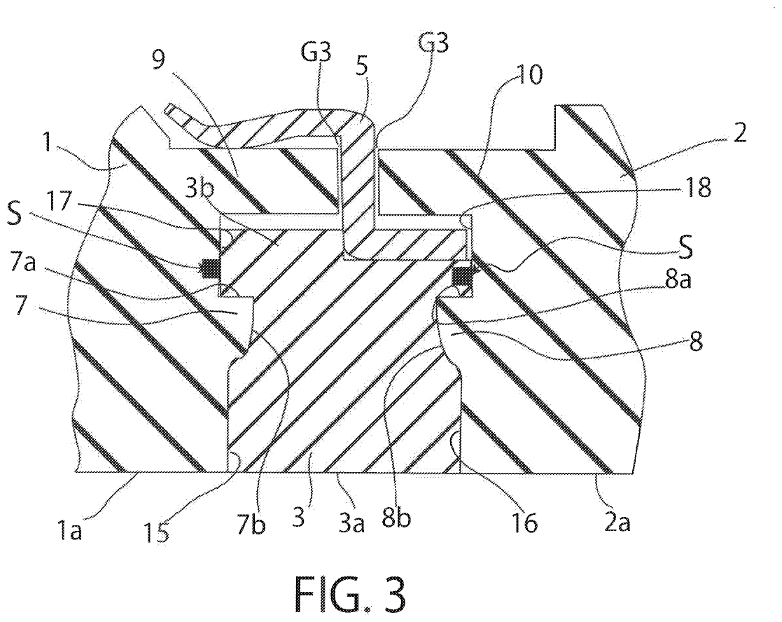

FIG. 1 to FIG. 3 show a pipe-joint type as a first embodiment of a sensor-equipped joint according to the present invention. FIG. 1 and FIG. 2 show a state obtained before the sensor-equipped joint is tightened and FIG. 3 shows a shape obtained after the sensor-equipped joint is tightened.

As shown in FIG. 1, the sensor-equipped joint includes a first pipe-shaped joint member (1), a second pipe-shaped joint member (2), an annular gasket (3) which can be interposed between a right end surface of the first pipe-shaped joint body (1) and a left end surface of the second pipe-shaped joint member (2) and a retainer (5) heled by the first pipe-shaped joint body (1) while retaining the annular gasket (3), and the second joint member (2) is fixed to the first joint body (1) by a nut (4) screwed to the first joint member (1) from the second joint member (2) side. Annular seal protrusions (7) (8) are respectively formed at approximately central parts in a radial direction of abutting end surfaces of the respective joint members (1) (2), and annular overtightening prevention protrusions (9) (10) are respectively formed in outer peripheral parts thereof.

Both end surfaces of the gasket (3) are flat surfaces perpendicular to an axial direction. A slip-off preventing part (3b) formed of an outward flange is provided on an outer peripheral surface of the gasket (3).

The both joint members (1) (2) and the gasket (3) are made of SUS 316L. Inner diameters of the both joint members (1) (2) and an inner diameter of the gasket (3) are formed to be equal. As materials for the both joint members (1) (2) and the gasket (3), stainless steel or other metals other than SUS 316L may be suitably adopted.

An inward flange (11) is formed in a right end part of the nut (4), and a portion of the flange (11) is fitted around the second joint member (2). A female screw (12) is formed on an inner periphery of a left end part of the nut (4), which is screwed to a male screw (14) formed on the right side of the first joint member (1). An outward flange (13) is formed on an outer periphery of a left end part of the second joint member (2), and a thrust ball bearing (6) for preventing co-rotation is interposed between the outward flange (13) and the inward flange (11) of the nut (4).

In the embodiment, one sensor (S) is embedded in the right end surface of the first pipe-shaped joint body (1) and one sensor (S) is embedded in a right end surface of the annular gasket (3).

As methods of providing the sensors, various methods such as a method in which recessed portions are formed in the joint member and the gasket to which the sensor is attached and the sensors are set therein to be embedded by using an adhesive or the like, a method in which the sensors are press-fitted to the recessed portions, a method by brazing and a method by powder metallurgy sintering can be adopted, but the present invention is not limited to these methods.

In a case where a signal from the sensor is taken out to the outside of the sensor-equipped joint by wire, a through hole for allowing a signal line to pass through is formed in the joint member or the gasket though not shown.

FIG. 2 specifically shows a relevant part of the pipe joint according to the first embodiment of the present invention. The respective seal protrusions (7) (8) have an arc shape in cross section, and inner-side flat surfaces (15) (16) and outer-side flat surfaces (17) (18) are formed on both inner and outer sides of the seal protrusions (7) (8) on respective abutting end surfaces. The inner-side flat surfaces (15) (16) protrude closer to the gasket (3) side in a left and right direction than the outer-side flat surfaces (17) (18).

The inner-side flat surfaces (15) (16) in FIG. 2 correspond to first flat surfaces and the outer-side flat surfaces (17) (18) correspond to second flat surfaces.

The respective overtightening prevention protrusions (9) (10) protrude closer to the gasket (3) side in the left and right direction than the respective seal protrusions (7) (8), which are configured to press the retainer (5) from both surfaces thereof at the time of performing tightening more tightly than proper tightening. The respective overtightening prevention protrusions (9) (10) protect the seal protrusions (7) (8) of the respective joint members (1) (2) before assembly, thereby preventing the seal protrusions (7) (8) from being damaged, which affects seal performance seriously.

FIG. 2 shows a state in which the nut (4) is tightened by hand in an enlarged manner. As shown in the same drawing, when the nut (4) is tightened, the protruding ends of the seal protrusions (7) (8) abut on end surfaces of the gasket (3) first. At this time, first gaps (G1) exist between the inner-side flat surfaces (15) (16) of the respective joint members (1) (2) and left-and-right end surfaces of the gasket (3), and second gaps (G2) larger than the first gaps (G1) respectively exist between the outer-side flat surfaces (17) (18) of the respective joint members (1) (2) and the left-and-right end surfaces of the gasket (3). Moreover, further larger third gaps (G3) exist between the overtightening prevention protrusions (9) (10) and the retainer (5). That is, G1<G2<G3. When the nut (4) is further tightened by using a wrench from the state of being tightened by hand, the gasket (3) is deformed and the first gaps (G1) becomes 0 (zero) first. At this time, the second gaps (G2) are not 0 (zero). Then, the second gaps (G2) also become 0 (zero) at the time of proper tightening as shown in FIG. 3 and the inner-side flat surfaces (15) (16) closely contact inner edge parts of left-and-right end surfaces of the gasket (3) so that inner peripheries (1a) (2a) of the respective joint members (1) (2) are approximately flush with an inner periphery (3a) of the gasket (3). That is, there is no recessed portion to be a liquid reservoir. The third gaps (G3) between the overtightening prevention protrusions (9) (10) and the retainer (5) are not 0 (zero) even in this stage. Then, when the nut (4) is further tightened, the third gaps (G3) between the overtightening prevention protrusions (9) (10) and the retainer (5) become 0 (zero) and resistance to the tightening becomes extremely high to prevent overtightening.

In the above first embodiment, the seal protrusions (7) (8) of the respective joint members (1) (2) are formed so that outer peripheral surfaces of base end parts of the seal protrusions (7) (8) extend in the axial direction. Contour shapes in cross section of the respective seal protrusions (7) (8) are formed by arc parts (7b) (8b) extending to an outer side in a radial direction from the abutting end surfaces of the respective joint members (1) (2) and straight line parts (7a) (8a) extending in the axial direction from the same end surfaces and connecting to tip ends of the arc parts (7b) (8b).

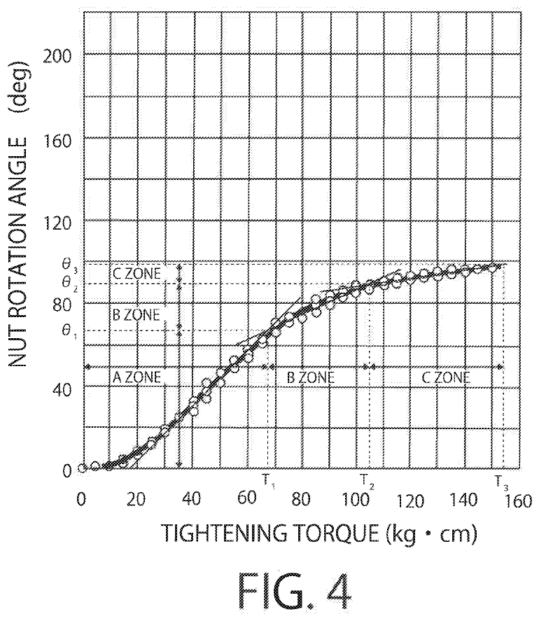

FIG. 4 is obtained by checking the relation between the rotation angle of the nut (4) plotted on the vertical axis and the tightening torque plotted on the horizontal axis concerning the first embodiment. In the sensor-equipped joint according to the first embodiment, a distance between the respective overtightening prevention protrusions (9) (10) and the retainer (5) at the time of being tightened by hand is set to 0.15 mm. Therefore, a distance between the respective overtightening prevention protrusions (9) (10) and the retainer (5) obtained when the outer-side flat surfaces (17) (18) abut on the gasket (3) is 0.03 mm based on calculation. Then, when the nut is rotated approximately 85 degrees from the state where the nut is tightened by hand as a reference, the overtightening prevention protrusions (9) (10) contact the retainer (5), which makes a gradient of a graph approximately horizontal. Therefore, reaction of tightening torque obtained when the nut (4) is rotated approximately 85 degrees is extremely large, which makes a person performing tightening work sense the end of tightening.

Based on more detailed observation of the graph of FIG. 4, it is found that the graph obtained by plotting the nut rotation angle and the tightening torque is divided into three zones. Three zones are an A-zone in a range from the rotation angle of 0 degrees to θ₁ degrees and the tightening torque of 0 to T₁, a B-zone in a range from the rotation angle of θ₁ degrees to θ₂ degrees and the tightening torque of T₁ to T₂ and a C-zone in a range from the rotation angle of θ₂ degrees to θ₃ degrees and the tightening torque of T₂ to T₃.

The A-zone is a zone from the rotation angle of nut (4) tightened by hand in an original point where the protruding ends of the seal protrusions (7) (8) abut on the end surfaces of the gasket (3) first to the rotation angle of θ₁ degrees of the nut (4) that is further tightened by the wrench or the like in a state where the gasket (3) is deformed and the first gaps (G1) become 0 (zero) first.

When the nut is further tightened from the rotation angle of θ₁ degrees, the second gaps (G2) also become 0 (zero) and the rotation angle of the nut is θ₂ degrees at that time. The zone in which the rotation angle of the nut is θ₁ degrees to θ₂ degrees is the B-zone.

When the nut is further tightened from the rotation angle of θ₂ degrees, the third gaps (G3) between the overtightening prevention protrusions (9) (10) and the retainer (5) become 0 (zero), and resistance to the tightening becomes extremely high. When the rotation angle of the nut at this time is θ₃ degrees, the zone in which the rotation angle of the nut is θ₂ degrees to θ₃ degrees is the C-zone.

It is found that a gradient of a straight line formed by connecting plotted points of FIG. 4 is reduced as the nut is rotated from the A-zone to the B-zone, and further, from the B-zone to the C-zone. This means that a higher tightening torque is generated by a smaller rotation angle as the graph is shifted from the A-zone to the B-zone, and further, from the B-zone to the C-zone.

A cause of loosening of the joint is loosening of the nut or contraction of a material in Embodiment 1. The torque is shifted from right to left of the graph in FIG. 4, which finally generates leakage of fluid.

The sensors provided in Embodiment 1 are provided on the outer-side flat surface (17)/(18) as the second flat surface and/or the position of the gasket (3) facing the outer-side flat surface (17)/(18) in the radial direction, which is the relation between the nut rotation angle and the tightening torque in the C-zone, therefore, the tightening torque is largely reduced with a slight loosening angle, and a surface pressure or distortion detected by the sensor can be detected with high sensitivity. Accordingly, when the sensors are provided at positions of the second gaps (G2) in the radial direction, loosening can be detected in an early stage of loosening with high sensitivity.

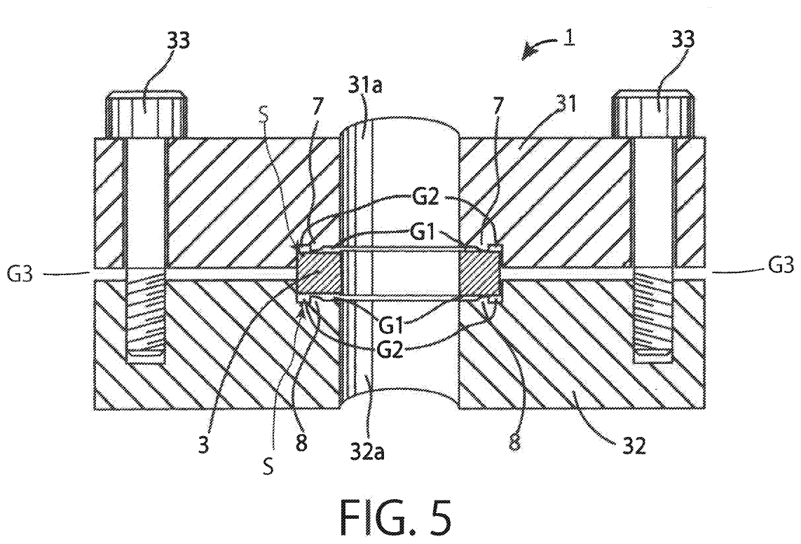

FIG. 5 shows Embodiment 2 in which sensors are provided in a block joint, not the pipe-shaped joint as in Embodiment 1. As shown in the drawing, a block joint (1) includes first and second block-shaped joint members (31) (32) having fluid passages (31a) (32b) communicating with each other, bolts (33) as tightening members for connecting the joint members (31) (32) to each other, the gasket (3), the retainer (not shown) and the sensors (S).

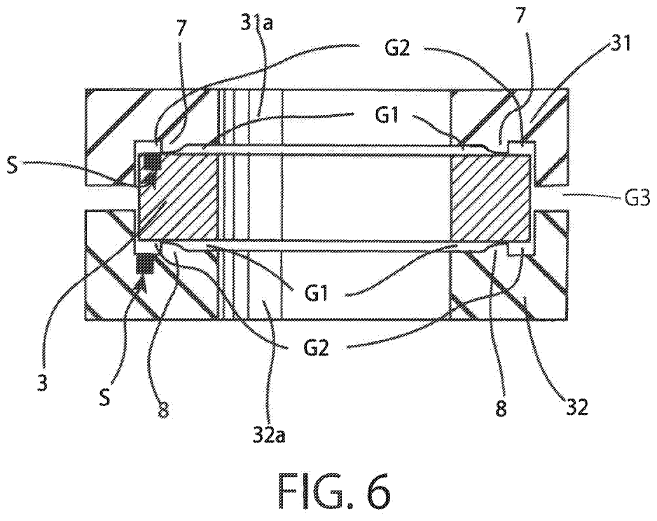

Also in Embodiment 2, a state where the bolts (33) are tightened by hand is shown in an enlarged manner in the same manner as Embodiment 1 as shown in FIG. 6 in which a relevant part of FIG. 5 is enlarged. As shown in the drawing, when the bolts (33) are tightened, the protruding ends of the seal protrusions (7) (8) abut on end surfaces of the gasket (3) first. At this time, first gaps (G1) respectively exist between inner-side flat surfaces (no symbol) of the respective block-shaped joint members (31) (32) and upper and lower end surfaces of the gasket (3), and second gaps (G2) larger than the first gaps (G1) respectively exist between outer-side flat surfaces (no symbol) of the respective block-shaped joint members (31) (32) and the upper and lower end surfaces of the gasket (3). Moreover, gaps more than twice larger than the second gaps (G2) exist between the block-shaped joint members (31) and (32). As the bolts (33) are further tightened by using the wrench or the like from the state of being tightened by hand, the gasket (3) is deformed and the first gaps (G1) become 0 (zero) first. At this time, the second gaps (G2) are not 0 (zero). Then, the second gaps (G2) also become 0 (zero) at the time of proper tightening and the inner-side flat surfaces (no symbol) closely contact inner edge parts of the upper and lower end surfaces of the gasket (3) though not shown. The inner peripheries of the respective block-shaped joint members (31) (32) become approximately flush with an inner periphery of the gasket (3). That is, there is no recessed portion to be a liquid reservoir. The gaps between the block-shaped joint members (31) and (32) are not 0 (zero) even in this stage. Then, when the bolts (33) are further tightened, the gaps become 0 (zero) and resistance to the tightening becomes extremely high to prevent overtightening.

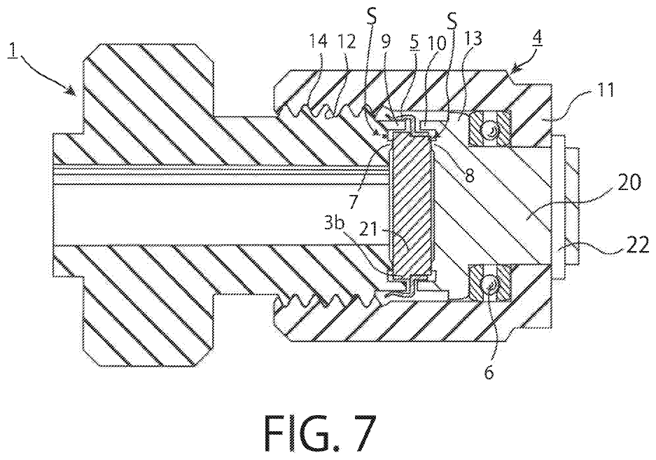

FIG. 7 shows the entire structure of a closing stopper in which the second pipe-shaped joint member (2) shown in FIG. 1 is replaced with a closing stopper body (20), a closing plate (21) and a slip-off preventing member (22). As the seal structure is the same as the joint shown in FIG. 1, the explanation is omitted.

In this closing stopper, the flow path is closed by the closing plate (21) and the closing stopper body (20) at this part, however, fluid flows to the first pipe-shaped joint member (1), therefore, the fact remains that the first pipe-shaped joint member (1) is the joint member forming the flow path even in the closing stopper having the above structure.

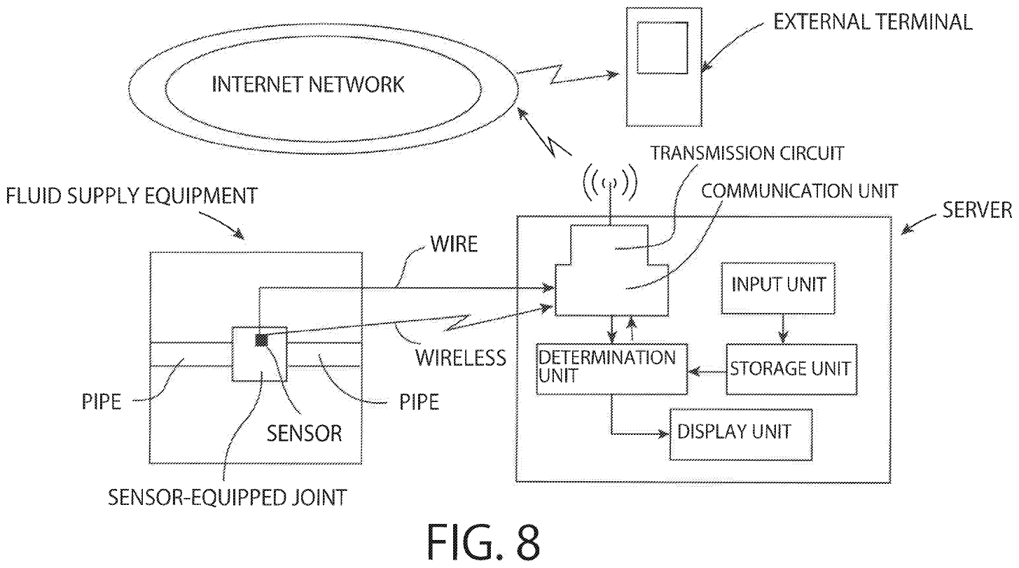

FIG. 8 shows a monitoring system including a server and the like for monitoring loosening of the sensor-equipped joint in fluid supply equipment having the sensor-equipped joint.

A detected signal is transmitted as information from the sensor of the sensor-equipped joint by wire or wireless to a communication unit of the server. A value corresponding to a magnitude of a signal obtained by multiplying a magnitude of a signal generated when leakage of fluid occurs by a safety factor is inputted to an input unit of the server, and the information is stored in a storage unit. A value corresponding to the magnitude of the signal received from the sensor and a value stored in the storage unit are compared in a determination unit. In a case where the value corresponding to the magnitude of the signal received from the sensor is smaller than the value stored in the storage unit, it is determined that the surface pressure or the like is reduced and starts to be loosened, therefore, information from the determination unit including a warning is transmitted to a display unit to thereby monitor the loosening of the sensor-equipped joint of the fluid supply equipment having the sensor-equipped joint.

As the information from the determination unit is associated with identification numbers of respective sensor-equipped joints, information concerning which joint requires maintenance can be obtained automatically.

In the system shown in FIG. 8, the communication unit of the server further includes a transmission circuit transmitting information from the determination unit including the warning, therefore, the information can be transmitted to an external terminal by using Internet network. Accordingly, the fluid supply equipment can be constantly monitored even in the outside other than a site where the fluid supply equipment exists and a room where the server is placed.

Warning information in the information from the determination unit specifically includes alarm screen display information to the display unit provided in the server or a display unit of the external terminal, sound warning information to a speaker provided in the server and a speaker of the external terminal, and other various warning information such as warning display information to a monitor screen provided in a monitoring room and warning sound information by a speaker and the like making sound to the entire plant.

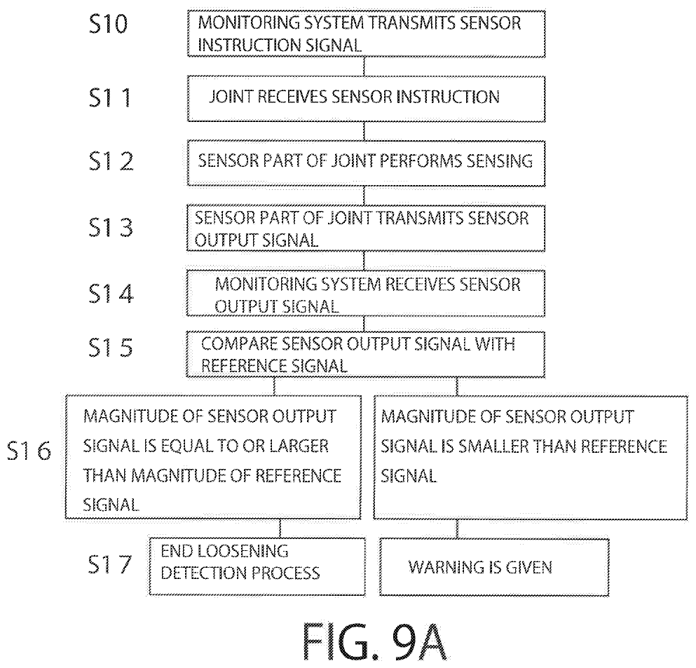

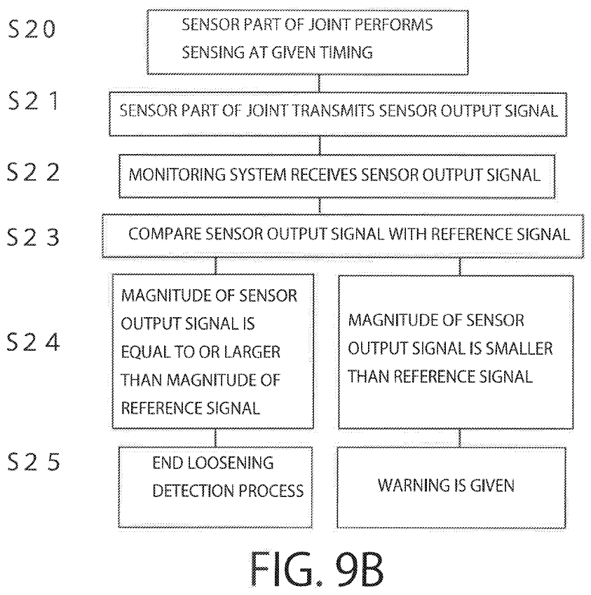

FIG. 9 is a view showing the flow from the start of monitoring in the monitoring system to the end of monitoring or transmission of the warning, in which FIG. 9-A shows the flow (S10 to S17) performed when a monitoring person transmits an instruction signal to the monitoring system, and FIG. 9-B shows the flow (S20 to S25) of monitoring performed by routine.

### REFERENCE SIGNS LIST

1: first pipe-shaped joint member

2: second pipe-shaped joint member

3: gasket

3b: slip-off preventing part

4: nut

5: retainer

6: ball bearing

7, 8: seal protrusion

7a, 8a: straight line part

7b, 7b: arc part

9, 10: overtightening prevention protrusion

11: flange

12: female screw

S: sensor

15, 16: inner-side flat surface (first flat surface)

17, 18: outer-side flat surface (second flat surface)

G1: first gap

G2: second gap

G3: third gap

21: closing plate

31, 32: block-shaped joint member

31a, 32a: fluid passage

33: bolt

1. A seal structure comprising:
a joint member forming a flow path; and
a gasket facing the joint member and forming a seal with respect to the joint member,
wherein a surface of the joint member facing the gasket includes a first flat surface, an annular seal protrusion protruding from the first flat surface and a second flat surface formed at a position more distant from the gasket as compared with the first flat surface, and
a sensor is provided in at least any one of the second flat surface and a part of the gasket facing the second flat surface.

2. The seal structure according to claim 1,
wherein the sensor is a strain sensor or a pressure sensor.

3. The seal structure according to claim 1,
wherein the first flat surface is positioned on an inner side than the annular seal protrusion, and the second flat surface is positioned on an outer side than the annular seal protrusion.

4. A joint comprising:
a pair of joint members forming a flow path;
an annular gasket interposed between the pair of joint members; and
a tightening means for connecting the pair of joint members,
wherein surfaces of the joint members facing the gasket include first flat surfaces, annular seal protrusions protruding from the first flat surfaces and second flat surfaces formed at positions more distant from the gasket as compared with the first flat surfaces, and
a sensor is provided in at least any one of the second flat surface and a part of the gasket facing the second flat surface.

5. The joint according to claim 4,
wherein the sensor is a strain sensor or a pressure sensor.

6. The joint according to claim 4,
wherein the first flat surfaces are positioned on an inner side than the annular seal protrusions, and the second flat surfaces are positioned on an outer side than the annular seal protrusions.

7. A closing stopper comprising:
a joint member forming a flow path;
a disc-shaped closing plate facing the joint member; and
a tightening means for connecting the joint member and the closing plate,
wherein a surface of the joint member facing the closing plate includes a first flat surface, an annular seal protrusion protruding from the first flat surface and a second flat surface formed at a position more distant from disc-shaped closing plate as compared with the first flat surface, and
a sensor is provided in at least any one of the second flat surface and a part of the closing plate facing the second flat surface.

8. The closing stopper according to claim 7,
wherein the sensor is a strain sensor or a pressure sensor.

9. The closing stopper according to claim 7,
wherein the first flat surface is positioned on an inner side than the annular seal protrusion, and the second flat surface is positioned on an outer side than the annular seal protrusion.

10. A monitoring system monitoring loosening of the joint in fluid supply equipment having the joint according to claim 4, comprising:
a communication unit receiving a signal from the sensor; and
a determination unit determining a pass/fail of a tightening state of the joint by comparing the signal received from the sensor with a given value.

11. The monitoring system according to claim 10,
wherein a warning is given when the tightening state is a fail.

12. A fluid supply apparatus having the monitoring system according to claim 11,
wherein a warning is given and a valve provided in the flow path including the joint is closed and opened.

13. The seal structure according to claim 2,
wherein the first flat surface is positioned on an inner side than the annular seal protrusion, and the second flat surface is positioned on an outer side than the annular seal protrusion.

14. he joint according to claim 5,
wherein the first flat surfaces are positioned on an inner side than the annular seal protrusions, and the second flat surfaces are positioned on an outer side than the annular seal protrusions.

15. The closing stopper according to claim 8,
wherein the first flat surface is positioned on an inner side than the annular seal protrusion, and the second flat surface is positioned on an outer side than the annular seal protrusion.

16. A monitoring system monitoring loosening of the joint in fluid supply equipment having the joint according to claim 5, comprising:
a communication unit receiving a signal from the sensor; and
a determination unit determining a pass/fail of a tightening state of the joint by comparing the signal received from the sensor with a given value.

17. A monitoring system monitoring loosening of the joint in fluid supply equipment having the joint according to claim 6, comprising:
a communication unit receiving a signal from the sensor; and
a determination unit determining a pass/fail of a tightening state of the joint by comparing the signal received from the sensor with a given value.

18. A monitoring system monitoring loosening of the joint in fluid supply equipment having the joint according to claim 14, comprising:
a communication unit receiving a signal from the sensor; and
a determination unit determining a pass/fail of a tightening state of the joint by comparing the signal received from the sensor with a given value.

19. The monitoring system according to claim 16,
wherein a warning is given when the tightening state is a fail.

20. A fluid supply apparatus having the monitoring system according to claim 19,
wherein a warning is given and a valve provided in the flow path including the joint is closed and opened.
